(19) United States
(12) Patent Application Publication
(10) Pub. No.: US 2014/0085040 A1
(43) Pub. Date: Mar. 27, 2014

(54) POWER SUPPLY APPARATUS WITH FRINGING FLUX SHIELDING ELEMENT

(71) Applicant: DELTA ELECTRONICS, INC., Taoyuan Hsien (TW)

(72) Inventors: Ching-Hui Cho, Taoyuan Hsien (TW); Yao-Ching Huang, Taoyuan Hsien (TW); Cueng-Han Yu, Taoyuan Hsien (TW)

(73) Assignee: DELTA ELECTRONICS, INC., Taoyuan Hsien (TW)

(21) Appl. No.: 13/718,360

(22) Filed: Dec. 18, 2012

(30) Foreign Application Priority Data
Sep. 25, 2012 (TW) 101218515

(51) Int. Cl. H01F 27/36

(52) U.S. Cl. CPC H01F 27/365
USPC 336/84 M; 336/84 R

(57) ABSTRACT

A power supply apparatus includes a magnetic element, a casing, and a shielding element. The magnetic element includes a magnetic core assembly. A fringing flux is generated by the magnetic core assembly. The casing is partially disposed over the magnetic element. The shielding element is arranged between the magnetic element and the casing for preventing the fringing flux from passing through the casing.

### FIELD OF THE INVENTION

The present invention relates to a power supply apparatus, and more particularly to a power supply apparatus with a fringing flux shielding element.

### BACKGROUND OF THE INVENTION

A transformer is used in an electronic circuit system for converting a voltage or electric power. Consequently, the transformer has become an essential magnetic element for regulating a voltage into desired voltages in order to power various kinds of electronic devices. For example, since a high frequency transformer is small-sized and light, the high frequency transformer is widely applied to a power supply apparatus or some other electronic devices. Generally, a transformer mainly comprises a bobbin, a core, plural pins, and plural winding coils.

For meeting the safety regulations about electromagnetic interference (EMI), the circuitry of the power supply apparatus is usually equipped with a metallic casing in order to prevent from radiation leakage. FIG. 1A is a schematic cross-sectional view illustrating a conventional power supply apparatus. As shown in FIG. 1A, the conventional power supply apparatus comprises a circuit board 10, a transformer 11, plural electronic components 12, and a metallic casing 13. Moreover, as shown in FIG. 1B, the transformer 11 comprises a magnetic core assembly 111.

Although the metallic casing 13 is effective to prevent from radiation leakage, there are still some drawbacks. For example, since the trends in designing the power supply apparatus are toward small size and light weightiness, the height of the transformer is gradually reduced. Consequently, as shown in FIG. 1A, the top surface of the transformer 11 is nearly in contact with the metallic casing 13. That is, the distance D between the metallic casing 13 and the transformer 11 is very small. Consequently, the fringing flux 113 generated around an air gap 112 between the middle posts 1111 of the magnetic core assembly 111 may pass through the metallic casing 13 (see FIG. 1C). The fringing flux 113 may induce an eddy current 131 on the metallic casing 13 (see FIG. 1D). Due to the eddy current 131 and the resistance of the metallic casing 13, the operation of the transformer 11 may generate eddy current loss. The eddy current loss may increase the temperature of the metallic casing 13. Consequently, the operating efficiency of the power supply apparatus is deteriorated and the working temperature of the power supply apparatus is increased. Moreover, the adjacent electronic components 12 are adversely affected. In addition, due to the fringing flux 113, the operating efficiency of the transformer 11 is also deteriorated.

Therefore, there is a need of providing a power supply apparatus with a fringing flux shielding element in order to reduce the influence of the fringing flux on the metallic casing.

### SUMMARY OF THE INVENTION

The present invention provides a power supply apparatus with a fringing flux shielding element in order to reduce the influence of the fringing flux on the metallic casing. Since the eddy current loss is reduced, the operating efficiency of the power supply apparatus is enhanced, the working temperature of the power supply apparatus is decreased, and the operating efficiency of the transformer is enhanced.

In accordance with an aspect of the present invention, there is provided a power supply apparatus. The power supply apparatus includes a magnetic element, a casing, and a shielding element. The magnetic element includes a magnetic core assembly. A fringing flux is generated by the magnetic core assembly. The casing is partially disposed over the magnetic element. The shielding element is arranged between the magnetic element and the casing for preventing the fringing flux from passing through the casing.

The above contents of the present invention will become more readily apparent to those ordinarily skilled in the art after reviewing the following detailed description and accompanying drawings, in which:

### BRIEF DESCRIPTION OF THE DRAWINGS

FIG. 1A is a schematic cross-sectional view illustrating a conventional power supply apparatus;

FIG. 1B is a schematic perspective view illustrating a magnetic core assembly of the conventional power supply apparatus of FIG. 1A;

FIG. 1C is a schematic cross-sectional view illustrating a portion of the conventional power supply apparatus of FIG. 1A;

FIG. 1D schematically illustrates the generation of an eddy current on the metallic casing of the conventional power supply apparatus of FIG. 1A;

FIG. 2A is a schematic perspective view illustrating a portion of a power supply apparatus according to a first embodiment of the present invention;

FIG. 2B is a schematic perspective view illustrating a portion of the power supply apparatus of FIG. 2A, in which the casing and the circuit board are not shown;

FIG. 2C is a schematic cross-sectional view illustrating a portion of the power supply apparatus of FIG. 2A, in which the shielding element is made of a magnetic and non-conductive material;

FIG. 2D is a schematic cross-sectional view illustrating a portion of the power supply apparatus of FIG. 2A, in which the shielding element is made of a magnetic and conductive material;

FIG. 3 is a schematic cross-sectional view illustrating a portion of a power supply apparatus according to another embodiment of the present invention;

FIG. 4A is a schematic perspective view illustrating the combination of a shielding element and a magnetic core assembly of a power supply apparatus according to another embodiment of the present invention; and

FIG. 4B is a schematic exploded view illustrating the power supply apparatus of FIG. 4A.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

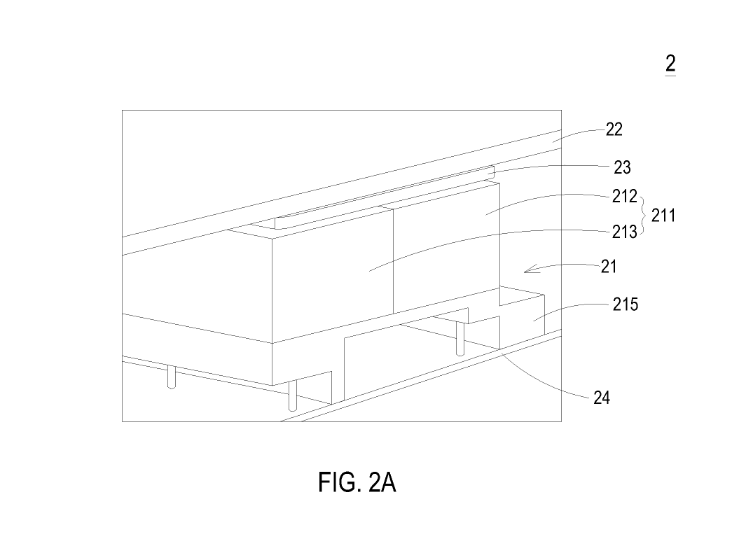

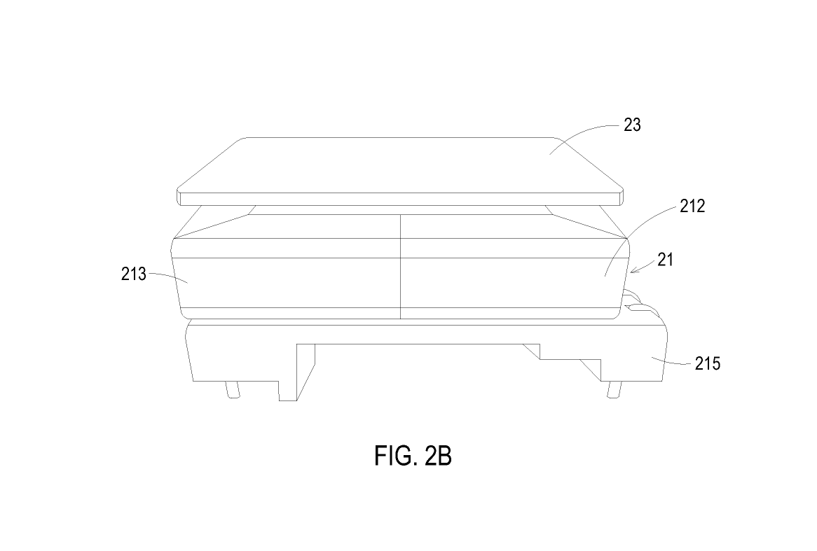

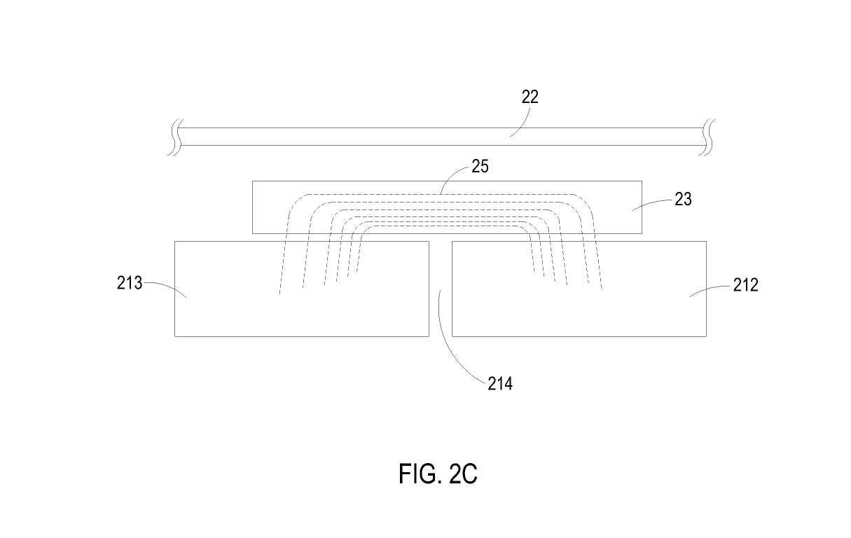

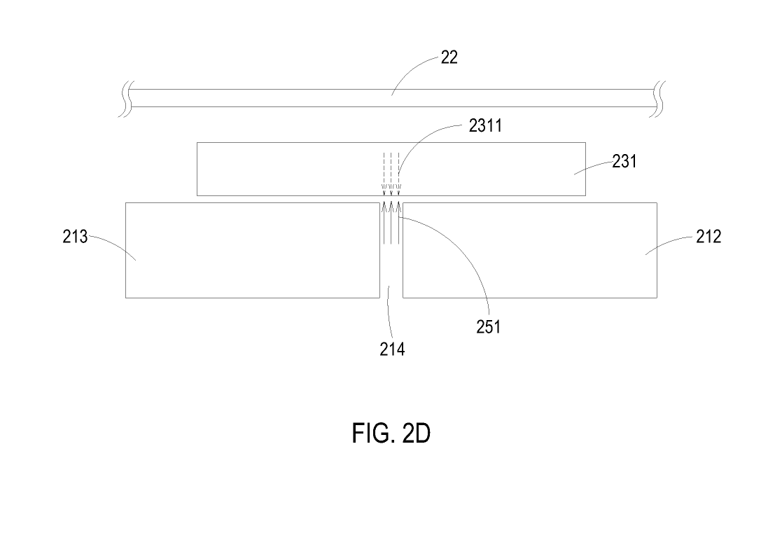

FIG. 2A is a schematic perspective view illustrating a portion of a power supply apparatus according to a first embodiment of the present invention. As shown in FIG. 2A, the power supply apparatus 2 comprises a magnetic element 21, a casing 22, a shielding element 23, and a circuit board 24. The magnetic element 21 is disposed on the circuit board 21. The magnetic element 21, the shielding element 23 and the circuit board 24 are disposed within the casing 22. In this embodiment, the casing 22 is made of a metallic material. Moreover, the shielding element 23 is arranged between the magnetic element 21 and the casing 22.

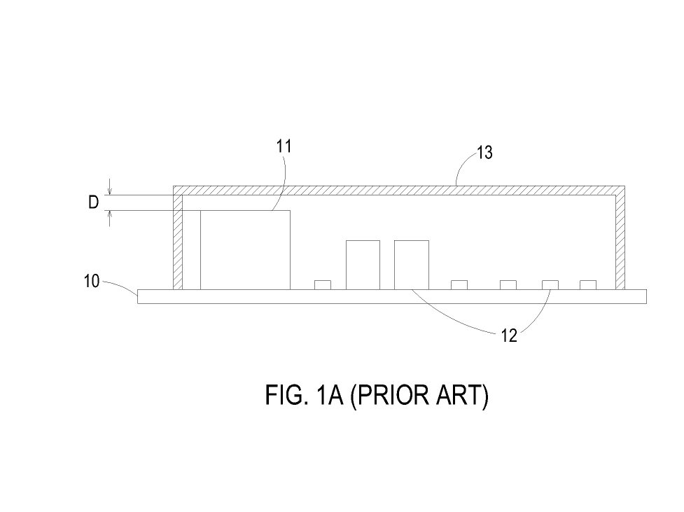

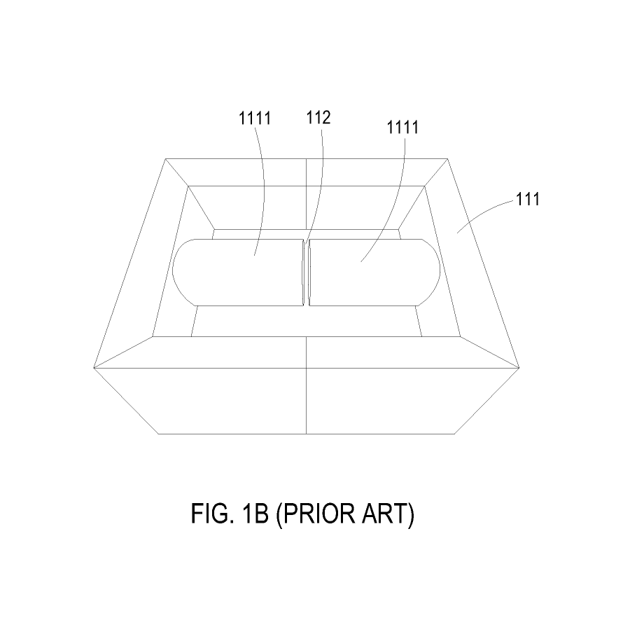

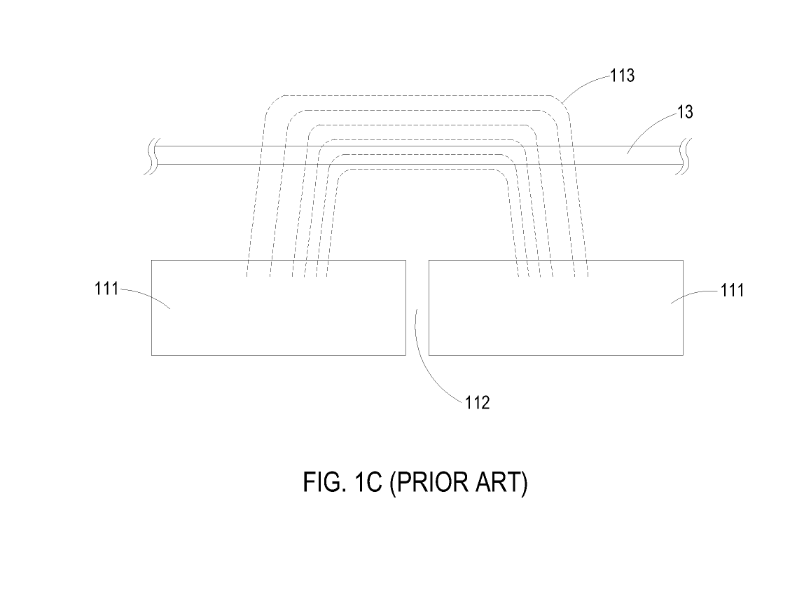

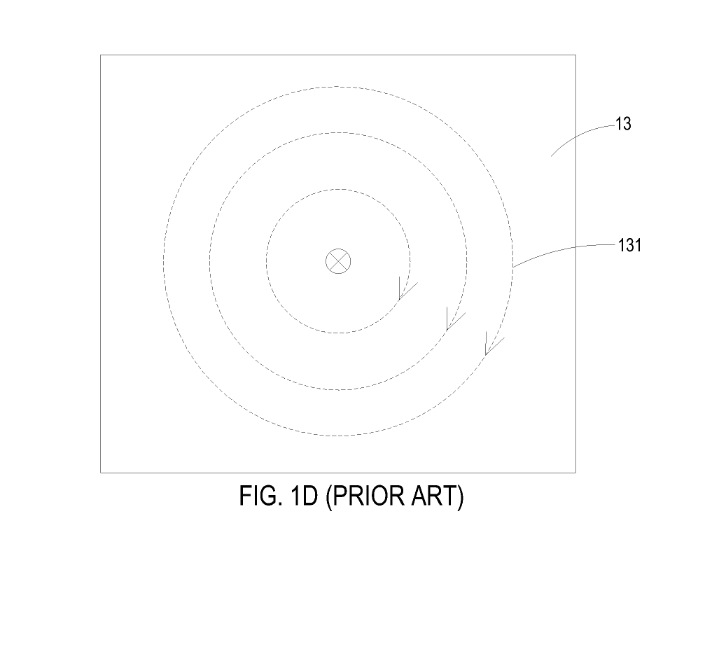

FIG. 2B is a schematic perspective view illustrating a portion of the power supply apparatus of FIG. 2A, in which the casing and the circuit board are not shown. FIG. 2C is a schematic cross-sectional view illustrating a portion of the power supply apparatus of FIG. 2A, in which the shielding element is made of a magnetic and non-conductive material. Please refer to FIGS. 2A, 2B and 2C. An example of the magnetic element 21 includes but is not limited to a transformer. In this embodiment, the magnetic element 21 comprises a magnetic core assembly 211 and a bobbin assembly 215. The structure of the magnetic core assembly 211 is similar to that of the magnetic core assembly 111 as shown in FIG. 1B. In this embodiment, the magnetic core assembly 211 is shaped as an EE-type core assembly, but is not limited thereto. Moreover, the magnetic core assembly 211 comprises a first core 212 and a second core 213. Each of the first core 212 and the second core 213 has a middle post, which is similar to that of the middle post 1111 of the magnetic core assembly 111 as shown in FIG. 1B. There is an air gap 214 between the middle post of the first core 212 and the middle post of the second core 213. During the operation of the magnetic element 21, a fringing flux 25 may be generated around the air gap 214 (see FIG. 2C).

Please refer to FIGS. 2A, 2B and 2C again. The shielding element 23 is arranged between a top surface of the magnetic element 21 and the casing 22. As shown in FIG. 2C, the shielding element 23 is disposed over the air gap 214 of the magnetic core assembly 211, so that the air gap 214 is completely sheltered by the shielding element 23. Due to the shielding element 23, the fringing flux 25 generated by the magnetic core assembly 211 does not pass through the casing 22. Under this circumstance, the problem of generating the eddy current loss will be eliminated. Since the working temperature of the power supply apparatus 2 is decreased, the operating efficiency is enhanced and the fabricating cost is reduced.

In this embodiment, the shielding element 23 is made of a magnetic and non-conductive material. An example of the shielding element 23 includes but is not limited to a ferrite core. The shielding element 23 is able to guiding the fringing flux 25 from the magnetic core assembly 211 and back to the magnetic element 21. That is, during the operation of the magnetic element 21, the fringing flux 25 generated around the air gap 214 between the first core 212 and the second core 213 is guided back to the magnetic element 21 by the shielding element 23. Due to the shielding element 23, the fringing flux 25 generated by the magnetic core assembly 211 does not pass through the casing 22. Under this circumstance, the problem of generating the eddy current loss will be eliminated. Since the working temperature of the power supply apparatus 2 is decreased, the operating efficiency is enhanced and the fabricating cost is reduced.

It is noted that numerous modifications and alterations may be made while retaining the teachings of the invention. FIG. 2D is a schematic cross-sectional view illustrating a portion of the power supply apparatus of FIG. 2A, in which the shielding element is made of a magnetic and conductive material. In this embodiment, the shielding element 231 is made of a magnetic and conductive material such as aluminum or copper. In a case that the shielding element 231 is made of aluminum, the shielding element 231 is an aluminum sheet or an aluminum foil. In this embodiment, the shielding element 231 may generate a magnetic field line 2311. The direction of the magnetic field line 2311 is opposed to the direction of the fringing flux 251, which is generated around the air gap 214 between the first core 212 and the second core 213. Consequently, the magnetic field line 2311 and the fringing flux 251 are offset from each other. Due to the shielding element 231, the fringing flux 251 generated by the magnetic core assembly 211 does not pass through the casing 22. Under this circumstance, the problem of generating the eddy current loss will be eliminated. Since the working temperature of the power supply apparatus 2 is decreased, the operating efficiency is enhanced and the fabricating cost is reduced.

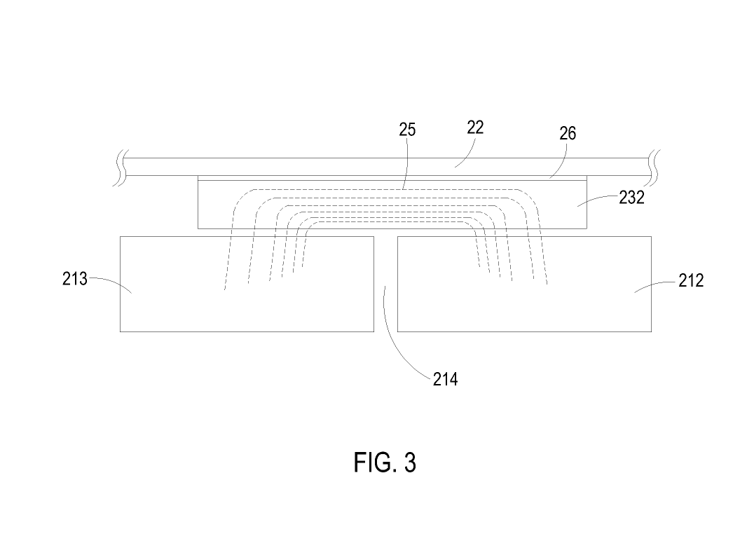

FIG. 3 is a schematic cross-sectional view illustrating a portion of a power supply apparatus according to another embodiment of the present invention. In comparison with the above embodiment, an adhesive layer 26 is arranged between the shielding element 232 and the casing 22. Via the adhesive layer 26, the shielding element 232 is attached on an inner surface of the casing 22. Consequently, the shielding element 232 is arranged between the magnetic element 21 and the casing 22, and disposed over the air gap 214 of the magnetic core assembly 211. Due to the shielding element 232, the fringing flux 25 generated by the magnetic core assembly 211 does not pass through the casing 22. Under this circumstance, the problem of generating the eddy current loss will be eliminated.

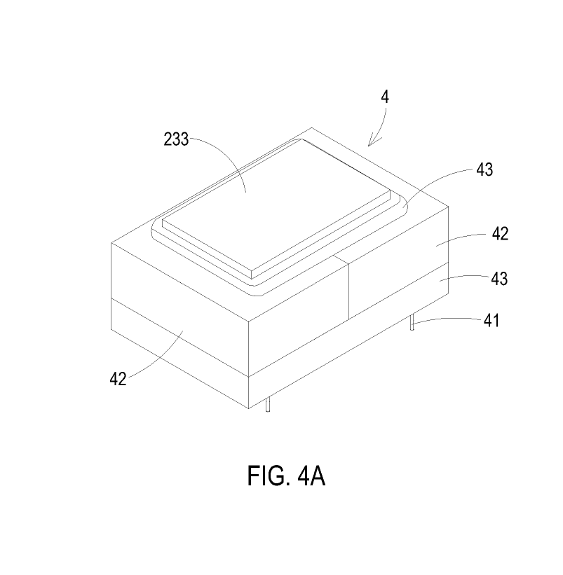

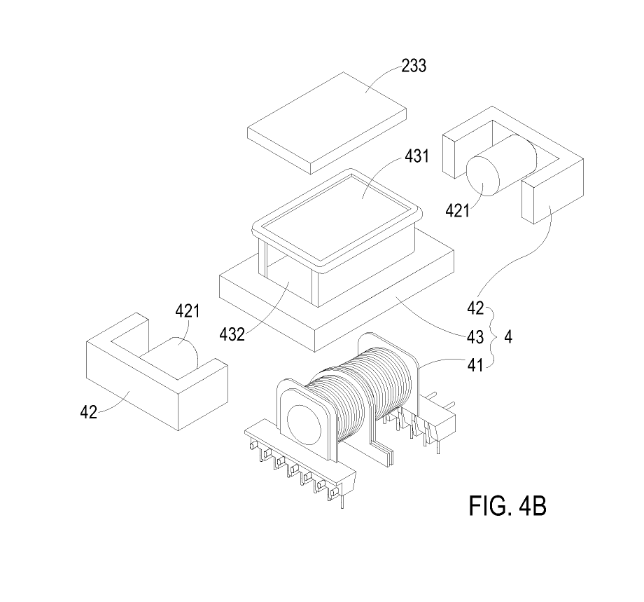

The way of attaching the shielding element on the inner surface of the casing is presented herein for purpose of illustration and description only. It is noted that numerous modifications and alterations may be made while retaining the teachings of the invention. FIG. 4A is a schematic perspective view illustrating the combination of a shielding element and a magnetic core assembly of a power supply apparatus according to another embodiment of the present invention. FIG. 4B is a schematic exploded view illustrating the power supply apparatus of FIG. 4A. Please refer to FIGS. 4A and 4B. In this embodiment, the magnetic element 4 of the power supply apparatus comprises a bobbin assembly 41, a magnetic core assembly 42, and an insulation cover 43. The insulation cover 43 is a hollow structure with two entrances 432 and a receiving space 431. The entrances 432 are aligned with corresponding middle posts 421 of the magnetic core assembly 42. The receiving space 431 is formed in a top surface of the insulation cover 43. The insulation cover 43 is used for covering the top side of the bobbin assembly 41. The middle posts 421 of the magnetic core assembly 42 are inserted into corresponding entrances 432 of the insulation cover 43. The shielding element 233 is accommodated within the receiving space 431. Consequently, the shielding element 233 is arranged between the magnetic element 4 and the casing (not shown), and disposed over the air gap of the magnetic core assembly 42. Due to the shielding element 233, the fringing flux generated by the magnetic core assembly 42 does not pass through the casing.

Hereinafter, the performance of the power supply apparatus of the present invention and the performance of the conventional power supply apparatus are compared with each other by referring to the eddy current loss. Experiments showed that the eddy current loss of the conventional power supply apparatus without the shielding element is about 7.44 watts. That is, since a large fraction of the fringing flux pass through the casing, the eddy current loss is very high. In a case that the shielding element of the present power supply apparatus is an aluminum foil, the eddy current loss at the casing is about 1.37 watt. In a case that the shielding element of the present power supply apparatus is a ferrite core, the eddy current loss at the casing is about 0.37 watt. In other words, the arrangement of the shielding element between the magnetic element and the casing according to the present invention can largely reduce the eddy current loss at the casing. Consequently, the performance of the power supply apparatus of the present invention is enhanced.

From the above descriptions, the present invention provides a power supply apparatus. The power supply apparatus comprises a magnetic element, a casing, and a shielding element. The magnetic element comprises a magnetic core assembly. Moreover, a fringing flux may be generated by the magnetic core assembly. The shielding element is arranged between a magnetic element and a casing in order to prevent the fringing flux from passing through the casing. Since the eddy current loss is reduced, the working temperature of the power supply apparatus is decreased, the operating efficiency of the power supply apparatus is enhanced, and the fabricating cost is reduced. In other words, the power supply apparatus with the shielding element according to the present invention is effective to eliminate the drawbacks of the conventional power supply apparatus.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply apparatus comprising:
a magnetic element comprising a magnetic core assembly, wherein a fringing flux is generated by said magnetic core assembly;
a casing partially disposed over said magnetic element; and
a shielding element arranged between said magnetic element and said casing for preventing said fringing flux from passing through said casing.

2. The power supply apparatus according to claim 1, wherein said magnetic element is a transformer.

3. The power supply apparatus according to claim 1, wherein said magnetic core assembly has an air gap, wherein said shielding element is disposed over said air gap, and said fringing flux is generated around said air gap.

4. The power supply apparatus according to claim 3, wherein said shielding element is attached on an inner surface of said casing via an adhesive layer, so that said shielding element is arranged between said magnetic element and said casing and disposed over said air gap of said magnetic core assembly.

5. The power supply apparatus according to claim 1, wherein said magnetic core assembly is as an EE-type core assembly.

6. The power supply apparatus according to claim 1, wherein said shielding element is made of a magnetic and non-conductive material, wherein by said shielding element, said fringing flux from said magnetic core assembly is guided back to said magnetic element, thereby preventing said fringing flux from passing through said casing.

7. The power supply apparatus according to claim 6, wherein said shielding element is a ferrite core.

8. The power supply apparatus according to claim 1, wherein said shielding element is made of a magnetic and conductive material, wherein said shielding element generates a magnetic field line in a direction reverse to said fringing flux, wherein said magnetic field line and said fringing flux are offset from each other, thereby preventing said fringing flux from passing through said casing.

9. The power supply apparatus according to claim 8, wherein said magnetic and conductive material is aluminum or copper.

10. The power supply apparatus according to claim 1, wherein said magnetic element further comprises a bobbin assembly and an insulation cover, wherein a receiving space is formed in a top surface of said insulation cover, and said shielding element is accommodated within said receiving space, so that said shielding element is arranged between said magnetic element and said casing.
